(19) United States
(12) Patent Application Publication
(10) Pub. No.: US 2026/0329260 A1
(43) Pub. Date: Oct. 22, 2026

(54) MULTIMODAL INDUSTRIAL DATA FUSION METHOD AND SYSTEM FOR DISCRETE MANUFACTURING

(71) Applicant: NANJING UNIVERSITY OF POSTS AND TELECOMMUNICATIONS, Nanjing (CN)

(72) Inventors: Haigen YANG, Nanjing (CN); Zhuang YANG, Nanjing (CN); Erhan DAI, Nanjing (CN); Yan GE, Nanjing (CN); Jixin LIU, Nanjing (CN); Fanyu ZENG, Nanjing (CN)

(21) Appl. No.: 19/697,025

(22) Filed: Jun. 3, 2026

Related U.S. Application Data
(63) Continuation of application No. PCT/CN2025/073810, filed on Jan. 22, 2025.

(30) Foreign Application Priority Data
Oct. 15, 2024 (CN) 202411435718.3

(51) Int. Cl. G05B 19/418; G06V 10/80; G06V 10/82

(52) U.S. Cl. CPC G05B 19/4183; G06V 10/80; G06V 10/82

(57) ABSTRACT

Disclosed in the present invention are a multimodal industrial data fusion method and system for discrete manufacturing. The method comprises: collecting discrete manufacturing industrial multimodal data in real time, performing feature extraction to obtain feature data, and inputting the feature data into a differentiable computer network to obtain a data fusion result, wherein a differentiable computer is further used for accomplishing a prediction objective on the basis of the data fusion result, and the differentiable computer network comprises a data fusion module and a memory system, the data fusion module fusing the feature data in an agent, and the memory system being used for storing and reading/writing re-fused data in the agent; and inputting the data in the memory system into an evaluation system to calculate a reward value, guiding the agent in data fusion on the basis of the reward value, and updating the memory system.

### TECHNICAL FIELD

The present disclosure relates to a data fusion method and system, and in particular to a multimodal industrial data fusion method and system for discrete manufacturing.

### BACKGROUND

Sensor technology widely used in the discrete manufacturing industry has generated a large amount of data. These data sources cover various aspects of a production environment, including equipment operating status, temperature, pressure, humidity, and other information. This data diversity and large scale provide a rich information source for data fusion. With the rapid development of the Internet of Things technology, the correlation between devices and systems has greatly improved. This means that data from various devices and systems can be more easily collected, transmitted, and integrated. This correlation improves the monitoring, optimization, and control of a production process, thereby improving production efficiency and quality levels.

The digital transformation of factories is becoming a major trend in the discrete manufacturing industry. This means that an amount of data involved in the production environment is constantly increasing, from sensor data to real-time monitoring data of the production process, as well as information related to a supply chain. Data is ubiquitous, and data fusion has become a key way to integrate, analyze, and apply these multi-source data.

Multimodal data fusion technology involves integrating multimodal data from different sensors or data sources. These data may include different types of data such as images, videos, sounds, and texts, and more comprehensive information is provided by fusing these data sources. As different data sources may have quality differences, including data inconsistencies, missing values, errors, or noise, the data fusion technology may be affected by these data quality problems, thereby resulting in inaccurate or unreliable fusion results. Moreover, data fusion techniques in the prior art cannot meet the needs of real-time processing and decision-making. Especially in industrial applications requiring fast response, processing and fusing a large amount of data may cause delays, affecting the effectiveness of real-time decision-making. In addition, conventional data fusion techniques cannot adapt to the constantly changing industrial environment and are insufficiently flexible in situations with frequent data changes and high complexity.

### SUMMARY

Objective: An objective of the present disclosure is to provide a multimodal industrial data fusion method and system for discrete manufacturing, which dynamically handles complex environmental problems through interactive learning between the environment and a large amount of data, maximizes the optimization of a data structure and dimension through a reward form with memory adaptive to an discrete manufacturing environment, and obtains a data fusion result, thereby providing guidance for a discrete manufacturing decision maker.

Technical solution: The multimodal industrial data fusion method for discrete manufacturing according to the present disclosure includes the following steps:
collecting discrete manufacturing industrial data in real time, performing feature extraction to obtain feature data, and inputting the feature data into a differentiable neural computer (DNC) network to obtain a data fusion result, where the DNC network is further configured to achieve a prediction objective on the basis of the data fusion result;
the discrete manufacturing industrial data includes video, text, image, and sound data; and
the DNC network includes a data fusion module and a memory system, where the data fusion module is configured to fuse the feature data in an agent, and the memory system is configured to store and read/write re-fused data in the agent; and
inputting the data in the memory system into an evaluation system to calculate a reward value, guiding the agent in data fusion on the basis of the reward value, and updating the memory system.

Further, the collecting discrete manufacturing industrial data in real time and performing feature extraction to obtain feature data includes: extracting semantic features of text data, extracting image features of image data, extracting frame features of video data, and extracting spectral features of sound data.

Further, the extracting semantic features of text data includes: converting a text into a set of words, assigning a weight to each word, where the weight is set according to a frequency of the word in the text and a distribution of the word in a corpus; and mapping the word to a high-dimensional space to obtain the semantic features of the text data;
the extracting image features of image data includes: using a Canny algorithm to extract image edges, and using a convolutional neural network to extract image features;
the extracting frame features of video data includes: extracting key frames from a video, and using a convolutional neural network to extract frame features; and
the extracting spectral features of sound data includes: extracting a spectrum of the sound data, and using a convolutional neural network to extract spectral features.

Further, the fusing the feature data in an agent through the data fusion module includes:
at a moment t, a controller receives a feature data input vector xₜ, obtains R read vectors

$$[ {γ}_{t - 1}^{1} , {γ}_{t - 1}^{2} , … . {γ}_{t - 1}^{R} , ]$$

from a storage matrix Mₜ₋₁ of the memory system, and processes these read vectors through an agent network to obtain an output vector yₜ;
at each moment, the agent network computes a network output vector vₜ and an interaction vector ξₜ, where the interaction vector is configured to parameterize an interaction between the agent and the memory system at the moment t,

$${v}_{t} = {w}_{y} [ {h}_{t}^{1} ; {h}_{t}^{2} ; … ; {h}_{t}^{L} ] , and {ξ}_{t} = {w}_{ξ} [ {h}_{t}^{1} ; {h}_{t}^{2} ; … ; {h}_{y}^{L} ] ;$$

in the formulas,

$${h}_{t}^{L}$$

represents an output of an L^{th} layer of the agent at the moment t, and w_{y} and w_{ξ} represent tap coefficients; and
the agent passes information back by creating a loop in the computation to obtain v^{t} and ξₜ; and the output vector of the agent is:

$${y}_{t} = {v}_{t} + {w}_{t} [ {γ}_{t}^{1} ; {γ}_{t}^{2} ; … ; {γ}_{t}^{R} ] ;$$

in the formula, wₜ represents a read weight.

Further, the controller is a Long Short-Term Memory network.

Further, in the evaluation system, an error between prediction of the prediction objective by the model and an actual objective is calculated, and the prediction error is used as a reward value to guide training of the DNC network.

Further, in the evaluation system, a game combination weight of the reward value is calculated, weighted summation is performed according to the game combination weight to obtain a weighted reward value, and parameters of the DNC network are adjusted according to the weighted reward value.

The multimodal industrial data fusion system for discrete manufacturing according to the present disclosure includes:
a feature extraction unit configured to collect discrete manufacturing industrial data in real time and perform feature extraction to obtain feature data; where the discrete manufacturing industrial data includes video, text, image, and sound data;
a data fusion unit configured to input the feature data into a DNC network to obtain a data fusion result, where the DNC network is further configured to achieve a prediction objective on the basis of the data fusion result; and the DNC network includes a data fusion module and a memory system, the data fusion module is configured to fuse the feature data in an agent, and the memory system is configured to store and read/write re-fused data in the agent; and
an evaluation unit configured to calculate a reward value according to the data in the memory system, guide the agent in data fusion on the basis of the reward value, and update the memory system.

An electronic device according to the present disclosure includes a processor, a memory, and a computer program stored in the memory and runnable on the processor, where the computer program, when loaded into the processor, implements the multimodal industrial data fusion method for discrete manufacturing.

A computer-readable storage medium according to the present disclosure stores a computer program, where the computer program, when executed by a processor, implements the multimodal industrial data fusion method for discrete manufacturing.

Beneficial effects: Compared with the prior art, the advantages of the present disclosure are as follows: The present disclosure fuses complex multimodal data collected in real time. The memory-augmented neural network of the present disclosure separates network training parameters from the capacity of the memory system, such that increasing the capacity of the memory system does not lead to an increase in the training parameters, reduces a large amount of training time, and facilitates the discrete manufacturing industry to save more time for decision-making.

### BRIEF DESCRIPTION OF THE DRAWINGS

FIG. 1 is a flowchart of a method of the present disclosure.

FIG. 2 is a structural diagram of a DNC model of the present disclosure.

FIG. 3 is a schematic diagram of an agent computation process of the present disclosure.

FIG. 4 is a schematic diagram of a read/write operation process of the present disclosure.

### DETAILED DESCRIPTIONS OF THE EMBODIMENTS

The technical solution of the present disclosure will be further described below in combination with the drawings.

Common memory systems include a Long Short-Term Memory (LSTM) network, a gated recurrent unit (GRU), and the like. To enhance the ability of an agent to cope with a complex environment, the prior art usually increases memory capacity by increasing the number of LSTM and GRU units. However, the number of network training parameters increases sharply as the capacity of a memory system increases, such that training becomes difficult.

The present disclosure separates the memory system from a parameter training process, and proposes using a memory-augmented neural network for multimodal data fusion. An agent reads or writes required information from or to the memory system and executes decisions. Moreover, a multimodal data fusion system feeds back a reward for actions performed by the agent, and this process is performed several times to ultimately maximize the reward.

A differentiable neural computer (DNC) is a neural network architecture with external memory, combining the learning capability of a neural network with the storage capability of the external memory. Using the DNC for data fusion may be performed by the following steps: A residual featurized dataset from a multimodal data module to be fused is collected, and it is ensured that features of the dataset are usable and clean. Data preprocessing is a key step to ensure data quality; and the DNC is used for implementation, and an input and an output of a model are determined. The input is data to be fused, and the output is a result after data integration. A DNC model is trained using a prepared dataset. During training, the model will learn how to effectively fuse data from different sources. The performance of the model is evaluated using a validation dataset. This helps to check whether the model may correctly fuse data and whether the model has good generalization ability. The model is debugged and improved according to the validation results.

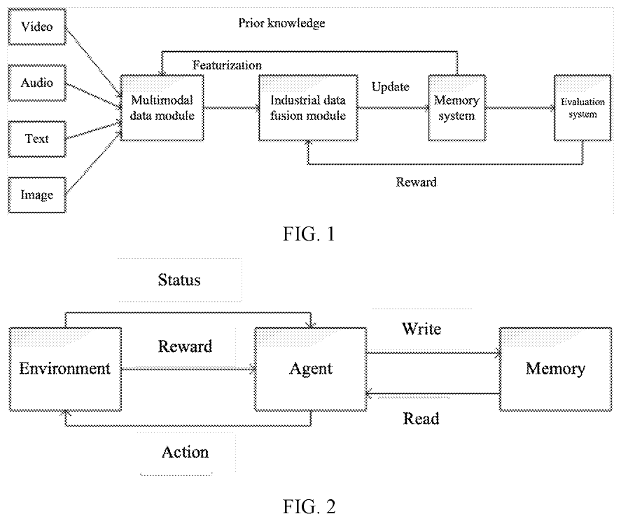

As shown in FIG. 1, a multimodal industrial data fusion method and system for discrete manufacturing includes the following steps.

S1, discrete manufacturing industrial data collected in real time from a discrete manufacturing workshop, such as a machining workshop, is transmitted to a multimodal data module for featurization.

S2, featurized data from the multimodal data module is transmitted to a DNC, where the DNC includes a discrete manufacturing industrial data fusion module and a memory system, which are configured to respectively perform discrete manufacturing industrial data fusion and memory read/write, and output a data fusion result.

S2-1, data from the memory system is input into an evaluation system, evaluation is performed according to conventional evaluation indicators, and simultaneously the data from the memory system is fed back to the multimodal data module; and

S2-2, a reward according to the evaluation feedback is fed back to the industrial data fusion module in the discrete mechanical manufacturing industrial workshop to guide data fusion, thereby continuously updating the memory system.

In S1, various types of industrial data of discrete manufacturing collected in real time from the discrete manufacturing mechanical workshop (including, for example, from a machining workshop: text data recorded in real time in the workshop, video data under surveillance, audio data recording machine status, image data generated during workshop production) are featurized.

The steps of the featurization are as follows:
(1) A text is converted into a set of words without considering an order of the words, and a weight is assigned to each word, where the weight takes into account a frequency of the word in the document and a distribution of the word in a corpus. The word is mapped to vectors in a high-dimensional space, and the semantic and contextual information of the word are preserved.
(2) The distribution of colors in an image is described, a Canny algorithm is used to extract image edges, and a convolutional neural network (CNN) is used to automatically extract image features.
(3) Key frames are extracted from a video, and the motion of pixels between different frames is described. Temporal and spatial information is combined, and a CNN deep learning model is used to extract features.
(4) Spectral features of an audio signal are described, and widely used in speech recognition. The CNN is used to extract audio features.

In S2, a conventional artificial neural network (ANN) integrates computation and storage when processing data, whereas the DNC may be regarded as a combination of the ANN and an external storage matrix, composed of a controller and a memory system, and the DNC may selectively read from and write to the storage, and iteratively modify the stored data. Using the storage matrix of the memory system, the DNC may obtain inference information, store important data during an inference process, and improve inference efficiency by simulating the inference process of a human brain.

The core of the DNC is the controller, which is responsible for processing task-related computations. Then, through memory reading, a controller network reads information from the external memory. The external memory of the DNC is readable and writable, similar to computer memory. This step enables the DNC to access previously stored information, thereby fusing historical information. The neural network then generates an output, including a prediction or decision for a task. This output is guided by the controller network so as to fully utilize the information in the memory. Then, according to the output of the task, the controller network may write some information into the external memory. This process allows the DNC to store key information of the task for use in future tasks. Finally, backpropagation is performed to adjust parameters of the neural network according to the output of the DNC and an actual result. This ensures that the DNC learns how to more effectively utilize the information in the external memory.

Through this cycle, the DNC may continuously extract key information from the input data, integrate the key information into the memory system, and then output according to task requirements. This method combining memory and the neural network enables the DNC to perform better than the conventional neural network on tasks with long-term dependencies.

The DNC of the present disclosure includes a data fusion module and a memory system. As shown in FIG. 2, the data fusion module continuously updates an agent to obtain the fusion result. At a moment t, the controller receives an input vector xₜ, obtains R read vectors

$${γ}_{t - 1}^{1} , {γ}_{t - 1}^{2} , … , {y}_{t - 1}^{R}$$

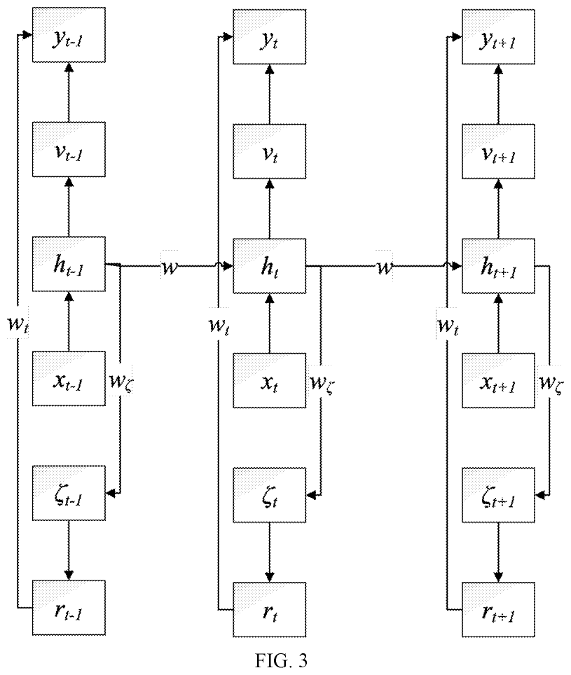

from the storage matrix Mₜ₋₁ of the memory system, processes these read vectors through an agent network to obtain an output vector yᵢ. FIG. 3 is a schematic diagram of an agent computation process.

The present disclosure uses the LSTM network as the controller network. At the moment t, an output value of layer I of the agent is

$${h}_{t}^{l} = LSTM ( {x}_{t} ) .$$

At each moment, the agent network computes a network output vector vₜ and an interaction vector ξₜ, where the interaction vector is configured to parameterize an interaction between the agent and the memory system at the moment t, and w_{y} and w_{ξ} represent tap coefficients;

$${v}_{t} = {w}_{t} [ {h}_{t}^{1} ; {h}_{t}^{2} ; … ; {h}_{t}^{L} ] ;$$

$${ξ}_{t} = {w}_{ξ} [ {h}_{t}^{1} ; {h}_{t}^{2} ; … ; {h}_{y}^{L} ] ;$$

the agent passes information back by creating a loop in a computation graph to obtain vₜ and the like; and finally, the output vector of the agent is:

$${y}_{t} = {v}_{t} + {w}_{t} [ {γ}_{t}^{1} ; {γ}_{t}^{2} ; … ; {γ}_{t}^{R} ] ;$$

in the formula, wₜ represents a read weight.

This design enables the agent to adjust output decisions by strengthening dependence on the storage matrix of the memory system.

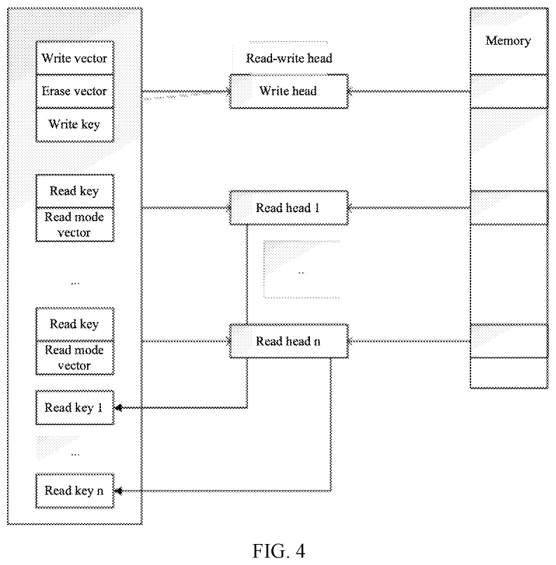

The agent operates on data in the memory system through read and write heads. FIG. 4 is a schematic diagram of a read/write head operation; and the positions for reading and writing are determined by corresponding weights. A non-negative quadrant of a standard simplex in a set RN of weights is allowed at N positions:

$${Δ}_{N} = \{ α ϵ {R}^{N} : {α}_{i} ∈ [ 0 , 1 ] , {\sum }_{i = 1}^{N} {α}_{i} \leq 1 \} ;$$

in a read operation, a plurality of read weights

$${w}_{t}^{r , 1} , {w}_{t}^{r 2} , … , {w}_{t}^{r ,} ∈ {Δ}_{N}$$

are used to compute a weighted average of the content, such that the read vector is defined as:

$${γ}_{t}^{i} = {M}_{t}^{T} {w}_{t}^{γ , i} ;$$

in a write operation, the write weight

$${w}_{t}^{w} ∈ {Δ}_{N}$$

combines with an erase vector e, and a write vector vₜ to modify the storage matrix of the memory system:

$${M}_{t} = {M}_{t - 1} ° ( E - {w}_{t}^{w} {e}_{t}^{T} ) + {w}_{t}^{w} {v}_{t}^{T} ;$$

in the formula, ° represents a Hadamard product which refers to an element-wise product of two matrices of the same order; and E represents an N×M matrix of all ones.

An addressing mechanism of the DNC is a combination of a plurality of approaches: When data is written to the memory system, content-based addressing and dynamic addressing are used; when data is read from the memory system, content-based addressing and temporal memory linking are used to obtain positions.

In S2-1 and S2-2, first, a prediction objective needs to be determined, which may be part of the task the model needs to learn. This objective is usually related to a main objective of the task but may be easier to obtain from the data. Existing data is used to train a DNC model to predict the prediction objective as accurately as possible. This may be completed by supervised learning, where labels of existing data or other available information are used to guide the learning of the model.

During training, an error between the prediction of the prediction objective by the model and an actual objective is calculated. This may be achieved by various loss functions, such as deviation minimization of wₘ. The prediction error is used as a reward value to guide the training of the model. Generally, a lower prediction error is regarded as a higher reward, while a higher error is regarded as a lower reward or penalty. This reward value may be mapped to a specific reward range through some transformation or normalization to ensure the stability and controllability of the reward value. The obtained reward value is used to optimize the model parameters to minimize the prediction error and improve the accuracy of the prediction objective. This usually involves using gradient descent or other optimization algorithms to update the model parameters, and adjusting the parameters according to a direction of the reward value.

In order to eliminate the influence of differences in dimensions on a final evaluation result, positive and negative reward values should be processed separately before data evaluation:

Any linear combination of weight vectors is:

$$w = {\sum }_{m = 1}^{C} {β}_{m} {W}_{m}^{T} ;$$

in the formula, βₘ is a linear combination coefficient

$${\sum }_{m = 1}^{C} {β}_{m} = 1 , and {β}_{m} > 0 .$$

The linear combination coefficient is optimized to minimize the deviation between w and each wₘ, i.e.:

$$min {‖ {\sum }_{m = 1}^{c} {β}_{i} {w}_{j}^{T} - {w}_{i}^{T} ‖}^{2} ;$$

According to the properties of matrix differentiation, a first-order derivative condition of the above formula is:

$${\sum }_{j = 1}^{C} {β}_{j} {w}_{j} {w}_{j}^{T} = {w}_{i} {w}_{i}^{T} ;$$

A system of linear equations is:

$$( \begin{matrix}{w}_{1} {w}_{1}^{T} & {w}_{1} {w}_{2}^{T} & … & {w}_{1} {w}_{c}^{T} \\ {w}_{2} {w}_{1}^{T} & {w}_{2} {w}_{2}^{T} & … & {w}_{2} {w}_{c}^{T} \\ ⋮ & ⋮ & ⋱ & ⋮ \\ {w}_{c} {w}_{1}^{T} & {w}_{c} {w}_{2}^{T} & … & {w}_{c} {w}_{c}^{T}\end{matrix} ) ( \begin{matrix}{β}_{1} \\ {β}_{2} \\ ⋮ \\ {β}_{c}\end{matrix} ) = ( \begin{matrix}{w}_{1} {w}_{1}^{T} \\ {w}_{2} {w}_{2}^{T} \\ ⋮ \\ {w}_{c} {w}_{c}^{T}\end{matrix} ) ;$$

βₘ values are normalized:

$${β}_{i}^{*} = \frac{{β}_{m}}{{\sum }_{m 1}^{c} {β}_{m}} ;$$

A final game combination weight is a method that combines a plurality of evaluation criteria or factors in decision analysis. It is used in multi-criteria decision problems, especially when there are conflicting objectives or criteria. This method incorporates the idea of game theory to identify the best compromise solution by assigning weights to different criteria or factors. The game combination weight is as follows:

$${w}^{*} = {\sum }_{m = 1}^{c} {β}_{i}^{*} {W}_{m}^{T} ;$$

The weighted total scores of various solutions are compared, and the solution with the highest score is selected as the best choice. Finally, the required evaluation feedback is obtained and transmitted to the fusion module. Key features are extracted from the data collected from the evaluation system. These features should represent core indicators of the evaluation system. The extracted features are fused with existing manufacturing data. Through continuous evaluation, data collection, analysis, and feedback, a closed-loop optimization system is formed to continuously improve the manufacturing process.

An auto parts manufacturing workshop is taken as an example, and a production process on a production line is monitored using monitoring cameras, sensors, and sound acquisition devices. The data generated by these devices includes different types of data such as images, videos, sounds, and texts.

Monitoring cameras: capture an assembly process of parts on the production line in real time.

Sensors: record physical parameters such as temperature, humidity, pressure, and vibration on the production line.

Sound acquisition devices: record abnormal sounds during the production process, machine operation sounds, and the like.

Text data: for example, worker log records, equipment maintenance reports, and the like.

The data fusion method for this workshop includes the following steps.
(1) Data integration: Data is integrated from different devices into a unified data platform, a uniform data format is ensured, and missing values and outliers are handled.
(2) Feature extraction: Features are extracted from the integrated data, and features related to production efficiency, product quality, and safety are extracted. For image and video data, computer vision technology may be used to extract information such as objects in images and the status of the production line. For sound data, information such as sound spectrum features and frequency distribution may be extracted. For text data, natural language processing may be performed to extract information such as keywords and sentiment analysis.
(3) Model building: A DNC model is built. The DNC is a neural network architecture with external memory, combining the learning capability of a neural network with the storage capability of the external memory. Using DNC for data fusion may be performed by the following steps: Data preparation: A dataset to be fused is collected. These data may come from different sources and have different features or formats. It is ensured that features of the dataset are usable and clean. Data preprocessing is a key step to ensure data quality. The model may predict abnormal conditions on the production line, optimize a production plan, or perform real-time monitoring and early warning according to the status of the production line.
(4) Model evaluation and optimization: The established model is evaluated and tuned using historical data to ensure that the model has good generalization ability. Techniques such as cross-validation may be used to evaluate the performance of the model, and adjustments and optimizations may be performed as needed.
(5) Real-time monitoring and feedback: The production plan or equipment parameters are adjusted in a timely manner according to monitoring results to achieve optimization and control of the production process. The established model is deployed into a real-time production environment and a real-time monitoring system is established to monitor the status of the production line. Through such a data fusion solution, the auto parts manufacturing workshop may better utilize multi-source data to optimize the production process, and improve product quality and safety, thereby reducing production costs and enhancing competitiveness.

The multimodal industrial data fusion system for discrete manufacturing according to the present disclosure includes:
a feature extraction unit configured to collect discrete manufacturing industrial data in real time and perform feature extraction to obtain feature data; where the discrete manufacturing industrial data includes video, text, image, and sound data;
a data fusion unit configured to input the feature data into a DNC network to obtain a data fusion result, where the DNC network is further configured to achieve a prediction objective on the basis of the data fusion result; and the DNC network includes a data fusion module and a memory system, the data fusion module is configured to fuse the feature data in an agent, and the memory system is configured to store and read/write re-fused data in the agent; and
an evaluation unit configured to calculate a reward value according to the data in the memory system, guide the agent in data fusion on the basis of the reward value, and update the memory system.

An electronic device according to the present disclosure includes a processor, a memory, and a computer program stored in the memory and runnable on the processor, where the computer program, when loaded into the processor, implements the multimodal industrial data fusion method for discrete manufacturing.

A computer-readable storage medium according to the present disclosure stores a computer program, where the computer program, when executed by a processor, implements the multimodal industrial data fusion method for discrete manufacturing.

The computer-readable storage medium may include a random access memory (RAM), a read-only memory (ROM), an erasable programmable read-only memory (EPROM), a compact disk read-only memory (CD-ROM) or other optical disk storage, magnetic disk storage or other magnetic storage devices, a flash memory, or any other medium that can be used to store desired program code in the form of instructions or data structures and that can be accessed by a computer.

The processor is configured to execute the computer program stored in the memory to implement the steps of the method involved in the above embodiment.

What is claimed is:

1. A multimodal industrial data fusion method for discrete manufacturing, comprising:
collecting, in real time from sensors, monitoring cameras, sound acquisition devices, and text records in a discrete manufacturing workshop, discrete manufacturing industrial data;
performing feature extraction on the discrete manufacturing industrial data to obtain feature data;
inputting the feature data into a differentiable neural computer (DNC) network to obtain a data fusion result, wherein the DNC network is configured to achieve, based on the data fusion result, a prediction objective associated with a production-line condition of the discrete manufacturing workshop; and
inputting data in a memory system of the DNC network into an evaluation system to calculate a reward value, guiding an agent in data fusion based on the reward value, and updating the memory system;
wherein the discrete manufacturing industrial data comprises video data, text data, image data, and sound data;
wherein the DNC network comprises a data fusion module and the memory system, the data fusion module is configured to fuse the feature data in the agent, and the memory system is configured to store and read/write re-fused data associated with the agent;
wherein fusing the feature data in the agent through the data fusion module comprises:
at a moment t, receiving, by a controller, a feature data input vector xₜ, obtaining R read vectors
$$[ {γ}_{t - 1}^{1} , {γ}_{t - 1}^{2} , … , {γ}_{t - 1}^{R} ]$$
from a storage matrix Mₜ₋₁ of the memory system, and processing the R read vectors through an agent network to obtain an output vector yₜ;
at each moment, computing, by the agent network, a network output vector vₜ and an interaction vector ξₜ, wherein the interaction vector is configured to parameterize an interaction between the agent and the memory system at the moment t, wherein:
$${v}_{t} = {w}_{y} [ {h}_{t}^{1} ; {h}_{t}^{2} ; … ; {h}_{t}^{L} ] ,$$
$$and$$
$${ξ}_{t} = {w}_{ξ} [ {h}_{t}^{1} ; {h}_{t}^{2} ; … ; {h}_{t}^{L} ] ;$$
wherein
$${h}_{t}^{L}$$
represents an output of an L^{th} layer of the agent at the moment t, and w_{y} and w_{ξ} represent tap coefficients; and
passing, by the agent, information back by creating a loop in computation to obtain vₜ and ξₜ; wherein the output vector yₜ of the agent is:
$${y}_{t} = {v}_{t} + {w}_{t} [ {γ}_{t}^{1} ; {γ}_{t}^{2} ; … ; {γ}_{t}^{R} ] ,$$
wherein w_t represents a read weight.

2. The multimodal industrial data fusion method for discrete manufacturing according to claim 1, wherein the collecting discrete manufacturing industrial data in real time and performing feature extraction to obtain feature data comprises: extracting semantic features of text data, extracting image features of image data, extracting frame features of video data, and extracting spectral features of sound data.

3. The multimodal industrial data fusion method for discrete manufacturing according to claim 2, wherein the extracting semantic features of text data comprises: converting a text into a set of words, and assigning a weight to each word, wherein the weight is set according to a frequency of the word in the text and a distribution of the word in a corpus; and mapping the word to a high-dimensional space to obtain the semantic features of the text data;
the extracting image features of image data comprises: using a Canny algorithm to extract image edges, and using a convolutional neural network to extract image features;
the extracting frame features of video data comprises: extracting key frames from a video, and using a convolutional neural network to extract frame features; and
the extracting spectral features of sound data comprises: extracting a spectrum of the sound data, and using a convolutional neural network to extract spectral features.

4. The multimodal industrial data fusion method for discrete manufacturing according to claim 1, wherein the controller is a Long Short-Term Memory network.

5. The multimodal industrial data fusion method for discrete manufacturing according to claim 1, wherein in the evaluation system, an error between the prediction objective predicted by the model and an actual objective is calculated, and the prediction error is used as a reward value to guide training of the DNC network.

6. The multimodal industrial data fusion method for discrete manufacturing according to claim 1, wherein in the evaluation system, a game combination weight of the reward value is calculated, weighted summation is performed according to the game combination weight to obtain a weighted reward value, and parameters of the DNC network are adjusted according to the weighted reward value.

7. A multimodal industrial data fusion system for discrete manufacturing, comprising:
a feature extraction unit configured to collect discrete manufacturing industrial data in real time and perform feature extraction to obtain feature data; wherein the discrete manufacturing industrial data comprises video, text, image, and sound data;
a data fusion unit configured to input the feature data into a DNC network to obtain a data fusion result, wherein the DNC network is further configured to achieve, based on the data fusion result, a prediction objective associated with a production-line condition of a discrete manufacturing workshop; and the DNC network comprises a data fusion module and a memory system, the data fusion module is configured to fuse the feature data in an agent, and the memory system is configured to store and read/write re-fused data in the agent; and
an evaluation unit configured to calculate a reward value according to the data in the memory system, guide the agent in data fusion on the basis of the reward value, and update the memory system; wherein
in the data fusion unit, the fusing the feature data in an agent through the data fusion module comprises:
at a moment t, a controller receives a feature data input vector xₜ, obtains R read vectors
$$[ {γ}_{t - 1}^{1} , {γ}_{t - 1}^{2} , … , {γ}_{t - 1}^{R} ]$$
from a storage matrix Mₜ₋₁ of the memory system, and processes these read vectors through an agent network to obtain an output vector yₜ;
at each moment, the agent network computes a network output vector vₜ and an interaction vector ξₜ, wherein the interaction vector is configured to parameterize an interaction between the agent and the memory system at the moment t,
$${v}_{t} = {w}_{y} [ {h}_{t}^{1} ; {h}_{t}^{2} ; … ; {h}_{t}^{L} ] ,$$
$$and$$
$${ξ}_{t} = {w}_{ξ} [ {h}_{t}^{1} ; {h}_{t}^{2} ; … ; {h}_{t}^{L} ] ;$$
in the formulas,
$${h}_{t}^{L}$$
represents an output of an L^{th} layer of the agent at the moment t, and w_{y} and w_{ξ} represent tap coefficients; and
the agent passes information back by creating a loop in the computation to obtain vₜ and ξₜ; and the output vector of the agent is:
$${y}_{t} = {v}_{t} + {w}_{t} [ {γ}_{t}^{1} ; {γ}_{t}^{2} ; … ; {γ}_{t}^{R} ] ;$$
in the formula, wₜ represents a read weight.

8. An electronic device, comprising a processor, a memory, and a computer program stored in the memory and runnable on the processor, wherein the computer program, when loaded into the processor, implements the multimodal industrial data fusion method for discrete manufacturing according to claim 1.
